(19) United States
(12) Patent Application Publication
(10) Pub. No.: US 2025/0260442 A1
(43) Pub. Date: Aug. 14, 2025

(54) SYSTEM AND METHOD FOR INTELLIGENT JOINT SLEEP, POWER AND RECONFIGURABLE INTELLIGENT SURFACE (RIS) CONTROL

(71) Applicant: Telefonaktiebolaget LM Ericsson (publ), Stockholm (SE)

(72) Inventors: Hao ZHOU, Ottawa (CA); Melike EROL-KANTARCI, Ottawa (CA); Medhat ELSAYED, Nepean (CA); Majid BAVAND, Ottawa (CA); Raimundas GAIGALAS, Hässelby (SE); Steve FURR, Ottawa (CA)

(73) Assignee: Telefonaktiebolaget LM Ericsson (publ), Stockholm (SE)

(21) Appl. No.: 18/992,568

(22) PCT Filed: Aug. 11, 2023
(86) PCT No.: PCT/IB2023/058149

§ 371 Date: Jan. 9, 2025

Related U.S. Application Data
(60) Provisional application No. 63/397,059, filed on Aug. 11, 2022.

(51) Int. Cl. H04B 7/04; H04L 41/16; H04W 52/02

(52) U.S. Cl. CPC H04B 7/04013; H04L 41/16; H04W 52/0206

(57) ABSTRACT

A method and network nodes for intelligent joint sleep, power and reconfigurable intelligent surface (RIS) control are disclosed. According to one aspect, a method in a network node configured to communicate with a plurality of small base stations (SBSs) includes jointly determining sleep control, transmission power control and reconfigurable intelligent surface, RIS, control for the plurality of SBSs based at least in part on a fractional programming (FP) algorithm, the FP algorithm configured to maximize a data rate for a plurality of wireless devices (WDs).

### FIELD

The present disclosure relates to wireless communications, and in particular, to systems and method for intelligent joint sleep, power and reconfigurable intelligent surface (RIS) control.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Energy efficiency (EE) is a metric for green communications of 5G advanced and future 6G networks, and sleep control has been one of the widely considered approaches to enhance the EE of radio access networks (RAN). Sleep control turns network devices such as base stations (BS), also referred to as network nodes, to sleep mode selectively, which is can be implemented with low complexity and much less costly than other solutions.

On the other hand, reconfigurable intelligent surface (RIS) technology has emerged as a promising technique for 5G and 6G networks. In particular, a huge number of small and low power consumption elements are integrated into RIS, and each unit is equipped with reflect-arrays to amplify and forward the incoming signal. Since no power amplifier is needed, RIS consumes much less energy than conventional relay transceivers. Therefore, RIS has become an ideal solution to improve the EE of RAN networks.

Machine learning techniques offer promising opportunities for intelligent network management and control. Advantages of machine learning algorithms have been extensively studied. For example, reinforcement learning can provide a long-term dynamic optimization by constantly exploring the task, which can intelligently adapt to complicated wireless environments such as traffic load levels, channel conditions, interference levels, etc.

Machine learning techniques have been widely investigated for wireless network management, including Q-learning, deep Q-learning, actor-critic learning, etc. For example, Q-learning and deep Q-learning have been described for energy sharing of renewable energy powered base stations to reduce energy footprint. A deep Q-learning-based scheme has been described with action-wise experience replay and adaptive reward scaling for sleep control. However, most existing schemes cannot handle network management problems with different timescales. For instance, sleep control is a long-term decision that affects the network performance of the following few time slots. By contrast, power control applies faster decision-making to adapt to the changing traffic demand of wireless devices (WDs). Therefore, such timescale obstacles in decision-making prevent/render difficult the application of conventional reinforcement learning algorithms.

### SUMMARY

Some embodiments advantageously provide methods and network nodes for intelligent joint sleep, power and reconfigurable intelligent surface (RIS) control.

A cooperative hierarchical deep reinforcement learning (Co-HDRL) algorithm for the joint sleep and power control of heterogeneous networks (HetNets) is disclosed. In some embodiments, the algorithm is capable of handling problems with different timescale actions. In some embodiments, a fractional programming (FP) based method for RIS phase shift control in multi-BS and multi-RIS scenario is disclosed

In some embodiments, sleep control, transmission power control and RIS control are jointly determined to improve network EE. For sleep and power control, a Co-HDRL algorithm is disclosed, including a meta-controller for sleep control, and several sub-controllers for power control.

For RIS control, a fractional programming (FP)-based method applies an iterative optimization method to maximize the total transmission rate under given power levels.

Some embodiments include a system that jointly considers the sleep control, transmission power control and RIS control to improve network EE. A Co-HDRL algorithm is presented to handle the timescale difference between sleep and power control, and an FP-based method for RIS phase shift control in multi-BS and multi-RIS environments.

RIS have extremely low power consumption and low deployment cost, which makes them an ideal solution to enhance EE metric. Compared with existing machine learning algorithms, the disclosed Co-HDRL algorithm can better handle control problems with different timescales by applying cross-entropy and correlated equilibrium techniques.

According to one aspect, a network node configured to communicate with a plurality of small base stations, SBSs, is provided. The network node includes circuitry configured to jointly determine sleep control, transmission power control and reconfigurable intelligent surface, RIS, control for the plurality of SBSs based at least in part on a fractional programming, FP, algorithm, the FP algorithm configured to maximize a data rate for a plurality of WDs.

According to this aspect, in some embodiments, the processing circuitry is configured to determine a long-term on/off status of an SBS of the plurality of SBSs and to provide a policy instruction to the SBS. In some embodiments, the policy instruction is based at least in part on reward feedback from the SBS. In some embodiments, the processing circuitry is configured to determine a sleep control decision for the SBS based at least in part on a transmission demand level of the plurality of SBSs. In some embodiments, jointly determining the sleep control, transmission power control and RIS control includes determining an optimal phase shift of an RIS based at least in part on maximizing a signal to interference plus noise ratio, SINR. In some embodiments, the processing circuitry is configured to configure at least one of an SBS and an RIS based at least in part on the jointly determined controls. In some embodiments, jointly determining the jointly determined controls includes performing machine learning based at least in part on a measure of performance. In some embodiments, the performance measure includes an average energy efficiency of the plurality of SBSs.

According to another aspect, a method in a network node configured to communicate with a plurality of small base stations, SBSs, is provided. The method includes jointly determining sleep control, transmission power control and reconfigurable intelligent surface, RIS, control for the plurality of SBSs based at least in part on a fractional programming, FP, algorithm, the FP algorithm configured to maximize a data rate for a plurality of WDs.

According to this aspect, in some embodiments, the method includes determining a long-term on/off status of an SBS of the plurality of SBSs and to provide a policy instruction to the SBS. In some embodiments, the policy instruction is based at least in part on reward feedback from the SBS. In some embodiments, the method includes determining a sleep control decision for the SBS based at least in part on a transmission demand level of the plurality of SBSs. In some embodiments, jointly determining the sleep control, transmission power control and RIS control includes determining an optimal phase shift of an RIS based at least in part on maximizing a signal to interference plus noise ratio, SINR. In some embodiments, the method includes configuring at least one of an SBS and an RIS based at least in part on the jointly determined controls. In some embodiments, jointly determining the jointly determined controls includes performing machine learning based at least in part on a measure of performance. In some embodiments, the performance measure includes an average energy efficiency of the plurality of SBSs.

According to yet another aspect, a network node configured as a small base station, SBS, to communicate with a master base station, MBS, is provided. The network node includes processing circuitry configured to select an action based at least in part on a correlated equilibrium algorithm configured to maximize a function of a conditional probability of a set of actions for a given state of transmission demand by a plurality of wireless devices, WDs.

According to this aspect, in some embodiments, selecting the action is based at least in part on a policy instruction from the MBS. In some embodiments, the network node includes radio interface configured to transmit an indication of the selected action to the MBS. In some embodiments, the network node includes the radio interface is configured to transmit an indication of average efficiency to the MBS. In some embodiments, selecting an action is based at least in part on a first reward, the first reward being based at least in part on a throughput for each WD. In some embodiments, the first reward is based at least in part on a penalty factor to avoid overload. In some embodiments, selecting an action is based at least in part on one of a correlated equilibrium policy in an exploration period and a correlated equilibrium in an exploitation period.

According to another aspect, a method in a network node configured as a small base station, SBS, to communicate with a master base station, MBS, is provided. The method includes selecting an action based at least in part on a correlated equilibrium algorithm configured to maximize a function of a conditional probability of a set of actions for a given state of transmission demand by a plurality of wireless devices, WDs.

According to this aspect, in some embodiments, selecting the action is based at least in part on a policy instruction from the MBS. In some embodiments, the method includes transmitting an indication of the selected action to the MBS. In some embodiments, the method includes transmitting an indication of average efficiency to the MBS. In some embodiments, selecting an action is based at least in part on a first reward, the first reward being based at least in part on a throughput for each WD. In some embodiments, the first reward is based at least in part on a penalty factor to avoid overload. In some embodiments, selecting an action is based at least in part on one of a correlated equilibrium policy in an exploration period and a correlated equilibrium in an exploitation period.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for intelligent joint sleep, power and reconfigurable intelligent surface (RIS) control;

FIG. 8 is a flowchart of an example process in a network for intelligent joint sleep, power and reconfigurable intelligent surface (RIS) control;

FIG. 9 is an example of a control system in a heterogeneous network environment according to principles set forth herein;

FIG. 10 is a flowchart of an example process in a network node according to principles set forth herein; and

FIG. 11 is a block diagram of the interaction between MBS, SBSs and WDs.

### DETAILED DESCRIPTION

Before describing in detail example embodiments, it is noted that the embodiments reside primarily in combinations of apparatus components and processing steps related to intelligent joint sleep, power and reconfigurable intelligent surface (RIS) control. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. As used herein, like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (cNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (cNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide intelligent joint sleep, power and reconfigurable intelligent surface (RIS) control.

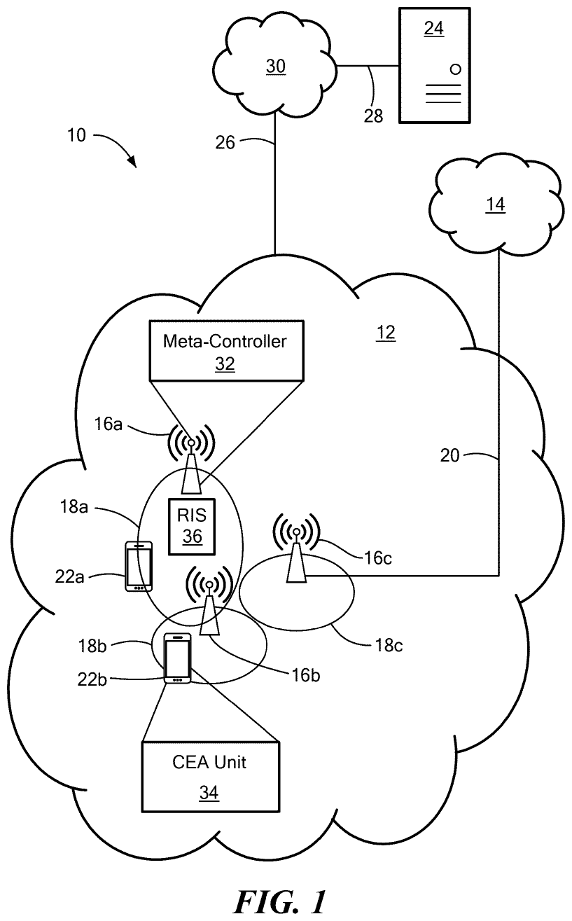

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. In some embodiments, the access network 12 is a heterogeneous network that includes a master base station (MBS) 16a and one or more small base stations (SBS) 16b, 16c. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN. As another example, a WD 22 can be in communication with an MBS 16a and one or more SBS 16b, 16c, simultaneously.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node operating as an MBS 16a is configured to include a meta-controller 32 which is configured to jointly determine sleep control, transmission power control and an RIS control for the plurality of SBSs 16b based at least in part on a fractional programming, FP, algorithm, the FP algorithm configured to maximize a data rate for a plurality of WDs. A network node operating as an SBS 16b is configured to include a correlated equilibrium algorithm (CEA) unit 34 which is configured to choose an action based at least in part on a correlated equilibrium algorithm configured to maximize a function of a conditional probability of a set of actions for a given state of transmission demand by a plurality of wireless devices, WDs. A reconfigurable intelligent surface 36 is configured to receive and transmit signals between two or more of network nodes 16a, 16b and 16c and/or WDs 22.

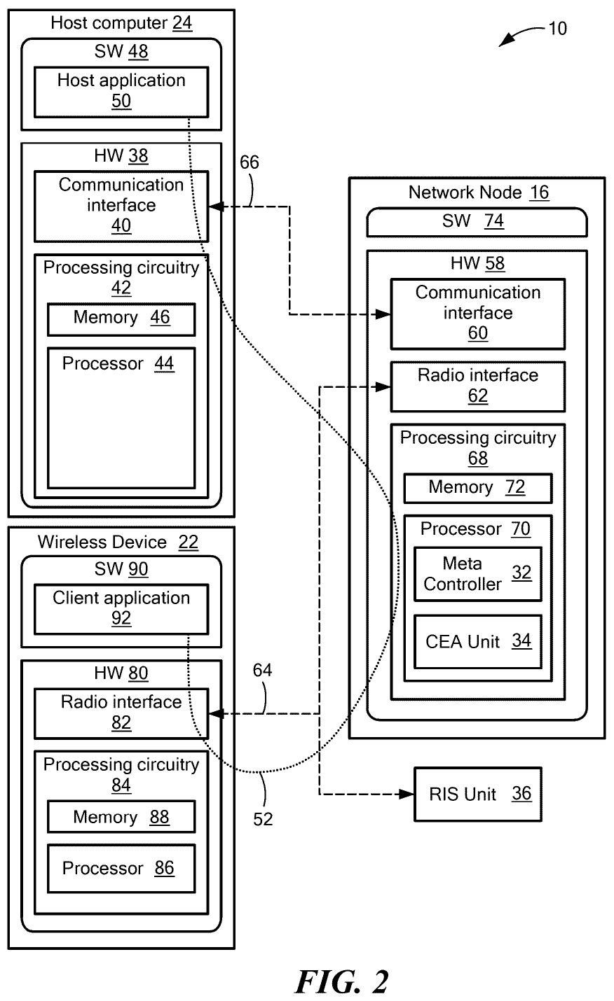

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16, when operating as an MBS 16a, may include the meta-controller 32 configured to jointly determine sleep control, transmission power control and reconfigurable intelligent surface, RIS, control for the plurality of SBSs 16b based at least in part on a fractional programming, FP, algorithm, the FP algorithm configured to maximize a data rate for a plurality of WDs 22. As another example, processing circuitry 68 of the network node 16, when operating as an SBS 16b, may include the CEA unit 34 configured to choose an action based at least in part on a correlated equilibrium algorithm configured to maximize a function of a conditional probability of a set of actions for a given state of transmission demand by a plurality of wireless devices, WDs.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as meta controller 32, and CEA unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

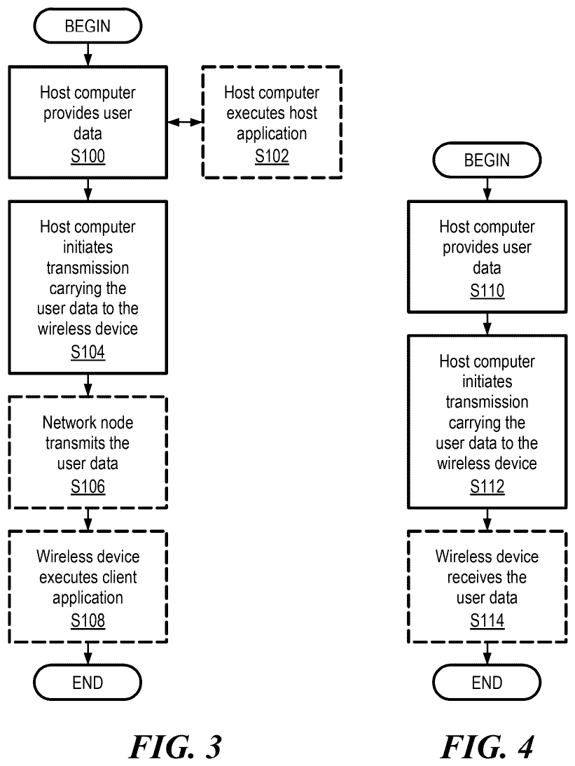

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

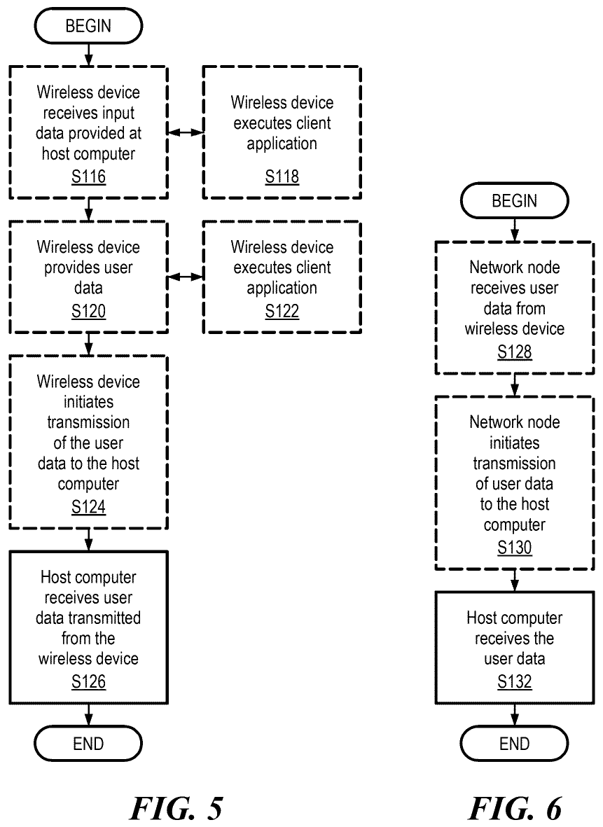

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

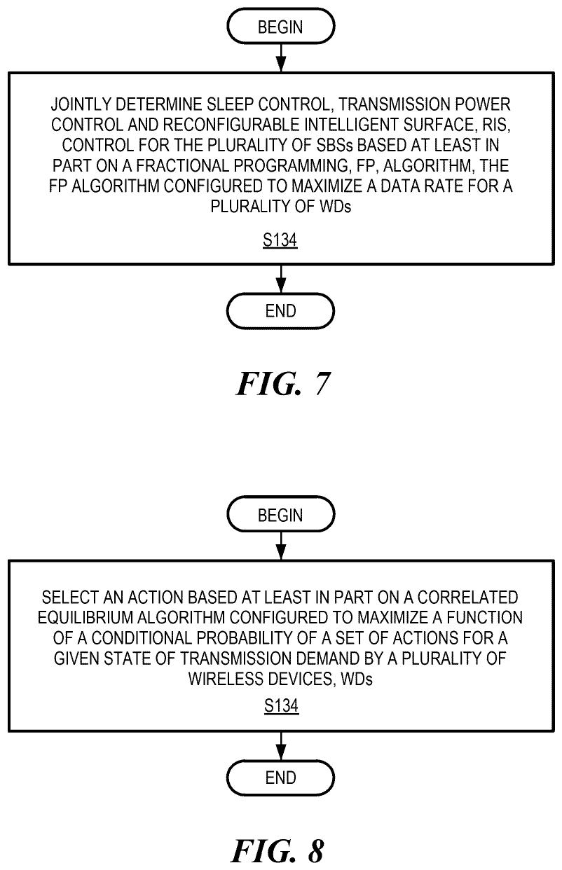

FIG. 7 is a flowchart of an example process in a network node 16 for intelligent joint sleep, power and reconfigurable intelligent surface (RIS) control. One or more blocks described herein may be performed by one or more elements of network node 16 such as by one or more of processing circuitry 68 (including the meta controller 32 and/or CEA unit 34), processor 70, radio interface 62 and/or communication interface 60. Network node 16 such as via processing circuitry 68 and/or processor 70 and/or radio interface 62 and/or communication interface 60 is configured to jointly determine sleep control, transmission power control and reconfigurable intelligent surface, RIS, control for the plurality of SBSs 16b based at least in part on a fractional programming, FP, algorithm, the FP algorithm configured to maximize a data rate for a plurality of WDs (Block S134).

In some embodiments, jointly determining the sleep control, transmission power control and RIS control includes determining an optimal phase shift of an RIS based at least in part on maximizing a signal to interference plus noise ratio (SINR). In some embodiments, the process includes configuring at least one of an SBS and an RIS based at least in part on the jointly determined controls. In some embodiments, jointly determining the controls includes machine learning based at least in part on a measure of performance. In some embodiments, the performance measure includes an average energy efficiency of the plurality of SBSs 16b. In some embodiments, the method includes determining a long-term on/off status of an SBS of the plurality of SBSs and to provide a policy instruction to the SBS. In some embodiments, the policy instruction is based at least in part on reward feedback from the SBS. In some embodiments, the method includes determining a sleep control decision for the SBS based at least in part on a transmission demand level of the plurality of SBSs. In some embodiments, jointly determining the sleep control, transmission power control and RIS control includes determining an optimal phase shift of an RIS based at least in part on maximizing a signal to interference plus noise ratio, SINR. In some embodiments, the method includes configuring at least one of an SBS and an RIS based at least in part on the jointly determined controls. In some embodiments, jointly determining the jointly determined controls includes performing machine learning based at least in part on a measure of performance. In some embodiments, the performance measure includes an average energy efficiency of the plurality of SBSs. FIG. 8 is a flowchart of an example process in a network node 16 for intelligent joint sleep, power and reconfigurable intelligent surface (RIS) control. One or more blocks described herein may be performed by one or more elements of network node 16 such as by one or more of processing circuitry 68 (including the meta controller 32 and/or CEA unit 34), processor 70, radio interface 62 and/or communication interface 60. Network node 16 such as via processing circuitry 68 and/or processor 70 and/or radio interface 62 and/or communication interface 60 is configured to select an action based at least in part on a correlated equilibrium algorithm configured to maximize a function of a conditional probability of a set of actions for a given state of transmission demand by a plurality of wireless devices, WDs (Block S136).

In some embodiments, choosing an action is based at least in part on a first reward, the first reward being based at least in part on a throughput for each WD. In some embodiments, the first reward is based at least in part on a penalty factor to avoid overload. In some embodiments, choosing an action includes choosing a transmission power based at least in part on the transmission demand. In some embodiments, selecting the action is based at least in part on a policy instruction from the MBS. In some embodiments, the method includes transmitting an indication of the selected action to the MBS. In some embodiments, the method includes transmitting an indication of average efficiency to the MBS. In some embodiments, selecting an action is based at least in part on a first reward, the first reward being based at least in part on a throughput for each WD. In some embodiments, the first reward is based at least in part on a penalty factor to avoid overload. In some embodiments, selecting an action is based at least in part on one of a correlated equilibrium policy in an exploration period and a correlated equilibrium in an exploitation period. Having described the general process flow of arrangements of the disclosure and having provided examples of hardware and software arrangements for implementing the processes and functions of the disclosure, the sections below provide details and examples of arrangements for intelligent joint sleep, power and reconfigurable intelligent surface (RIS) control.

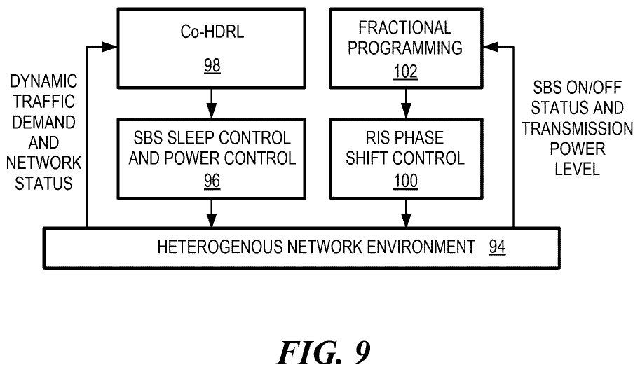

FIG. 9 shows a HetNets environment 94 having small base stations (SBS) 16b that can enter a sleep mode when transmission demand drops, which reduces energy consumption and increases the overall energy efficiency. Then, the MBS 16a may take over the active WDs that are previously covered by sleeping SBSs 16b. This can be achieved via SBS sleep and power control 96. Meanwhile, an SBS 16b can adjust its transmission power dynamically to achieve the desired signal to interference plus noise ratio (SINR) for attached WDs and reduce the interference on other SBSs 16b. In some embodiments, a Co-HDRL method 98 for joint sleep and power control 96 of SBSs 16b is implemented. Hereafter, MBS 16a and SBSs 16b will be referred to collectively as network nodes 16.

On the other hand, the direct transmission between network node 16 and WDs 22 may suffer high penetration loss due to dense buildings. Then RIS is deployed to reshape the signal transmission path from network node 16 to WDs 22 and increase the SINR. Note that one RIS can be shared by several network nodes, which means the RIS control 100 will simultaneously affect the performance of several network nodes. An fractional programming (FP)-based algorithm 102 for the RIS phase shift control is disclosed.

For RIS phase shift control, the FP-based method may be described as follows. The signal-to-interference-plus-noise ratio (SINR) of WD k is:

$${ψ}_{k} = \frac{{P}_{b} {\vert {\sum }_{m ∈ ℳ} {H}_{b , m} {Θ}_{m} {G}_{m , k}^{†} \vert}^{2}}{{\sum }_{{b}^{′} ∈ {ℬ}_{- b}} {P}_{{b}^{′}} {\vert {\sum }_{{m}^{′} ∈ ℳ} {H}_{{b}^{′} , m} {Θ}_{{m}^{′}} {G}_{{m}^{′} , k}^{†} \vert}^{2 + {N}_{0}^{2}}} \qquad ( F )$$

An objective of RIS phase shift control is to maximize the total data rate for all WDs, which is given by:

$$\begin{matrix}{max}_{{Θ}_{m}} & {f}_{1} ( {Θ}_{m} ) = {\sum }_{k ∈ 𝒦} {b}_{k} log ( 1 + {ψ}_{k} ) \\ s . t . & {\vert {θ}_{m , n} \vert}^{2} = 1 , m ∈ ℳ , n ∈ {𝒩}_{m}\end{matrix} \qquad ( G )$$

where [symbol] is the set of WDs.

Equation (G) is equivalent to:

$${max {f}_{2}}_{{Θ}_{m} , β} ( {Θ}_{m} , β ) = {\sum }_{k ∈ 𝒦} ( {b}_{k} log ( 1 + {β}_{k} ) - {b}_{k} {β}_{k} + \frac{{b}_{k} ( 1 + {β}_{k} ) {ψ}_{k}}{1 + {ψ}_{k}} ) \qquad ( H )$$

where β=[β₁, β₂, . . . , β_{|} [symbol] _{|}] is the auxiliary variable given by Lagrangian dual transform.

To solve the problem f₂, apply an iterative method to update the Θₘ and β alternatively. First, given Θₘ, setting

$$\frac{\partial {f}_{2}}{\partial {β}_{k}} = 0$$

claims βₖ*=ψₖ. Then, given βₖ*, optimizing Θₘ means:

$${max {f}_{3}}_{\hat{Θ}} ( \hat{Θ} ) = {\sum }_{k ∈ 𝒦} \frac{{b}_{k} ( 1 + {β}_{k} ) {\vert \hat{Θ} {V}_{b , k} \vert}^{2}}{{\sum }_{b ′ ∈ ℬ} {\vert \hat{Θ} {V}_{b ′ , k} \vert}^{2} + {N}_{0}^{2}} \qquad ( I )$$

For ease of notation, define \hat{Θ}=[\hat{θ}₁^{†}, \hat{θ}₂^{†}, . . . , [symbol] ], and \sqrt{P_{b}}H_{b,m} Θₘ G_{m,k}^{\} can be easily transformed to ωₘ\hat{θ}ₘ diag(H_{b,m})G_{m,k}^{†}\sqrt{P_{b}}. For notation brevity, further define v_{b,m,k}=ωₘ diag(H_{b,m})G_{m,k}^{†}\sqrt{P_{b}}. By using quadratic transformation, the following is obtained:

$$max {f}_{4} ( Θ , {η}_{k} ) = {\sum }_{k ∈ 𝒦} ( 2 \sqrt{{b}_{k} ( 1 + {β}_{k} )} ℝ \{ {η}_{k}^{†} ( \hat{Θ} {V}_{b , k} ) \} - {η}_{k}^{†} ( {\sum }_{b ′ ∈ ℬ} {\vert \hat{Θ} {V}_{b ′ , k} \vert}^{2} + {N}_{0}^{2} ) {η}_{k} ) \qquad ( J )$$

where η=[η₁, η₂, . . . [symbol] ] is a collection of auxiliary variables, [symbol] refers to the real number part, \hat{Θ}=[\hat{θ}₁^{H}, \hat{θ}₁^{H}, . . . , [symbol] ] represents all the RIS phase control variables, and V_{b,k}=[v_{b,1,k}, v_{b,2,k}, . . . , [symbol] ].

When \hat{Θ} is fixed, it is easy to get the optimal ηₖ* by:

$${η}_{k}^{*} = \frac{\sqrt{{b}_{k} ( 1 + {β}_{k} )} \hat{Θ} {V}_{b , k}}{{\sum }_{b ′ ∈ ℬ} {\vert \hat{Θ} {V}_{b ′ , k} \vert}^{2} + {N}_{0}^{2}} \qquad ( K )$$

Given (K), to optimize \hat{Θ}:

$${max {f}_{5}}_{\hat{Θ}} ( \hat{Θ} ) = - {\hat{Θ}}^{H} Λ \hat{Θ} + 2 ℝ \{ {Θ}^{H} Ψ \} + {\sum }_{k ∈ 𝒦} {\vert {η}_{k} \vert}^{2} {N}_{0}^{2} \qquad ( L )$$

Where Λ= [symbol] |ηₖ|² [symbol] |V_{b′,k}|² and

$$Ψ = {\sum }_{k ∈ 𝒦} 2 \sqrt{{b}_{k} ( 1 + {β}_{k} )} {η}_{k}^{†} {V}_{b , k} .$$

equation (L) is a quadratically constraint quadratic programming problem, but the phase shift constraint |θ_{m,n}|²=1 is non-convex. Therefore, this constraint may be relaxed by allowing |θ_{m,n}|²≤1 for convexity. The Lagrange dual of this problem can be written as an unconstrained problem:

$${max {f}_{7}}_{\hat{Θ} , \hat{σ}} ( \hat{Θ} , \hat{σ} ) = - {\hat{Θ}}^{H} Λ \hat{Θ} + 2 ℝ \{ {\hat{Θ}}^{H} Ψ \} - {\sum }_{m ∈ ℳ} {\sum }_{n ∈ 𝒩} {σ}_{m , n} ( {\vert {θ}_{m , n} \vert}^{2} - 1 ) \qquad ( M )$$

where σ_{m,n} is the Lagrange dual variable for each constraint with \hat{σ}=[σ₁, . . . , σₘ, . . . , [symbol] ], and σₘ=[σ_{m,1}, . . . , σ_{m,n}, . . . , [symbol] ]. Setting

$$\frac{\partial {f}_{7}}{\partial \hat{Θ}} = 0 ,$$

then the optimal \hat{Θ} is given by

$${\hat{Θ}}^{*} = \frac{Ψ}{Λ + diag ( \hat{σ} )} .$$

Substituting \hat{Θ} into equation (L), and using a Schur complement produces:

$${max}_{\hat{σ} , κ} {f}_{9} ( \hat{σ} , κ ) = κ - tr ( diag ( \hat{σ} ) ) \qquad ( N )$$

$$s . t . [ \begin{matrix}Λ + diag ( \hat{σ} ) & Ψ \\ {Ψ}^{†} & - κ\end{matrix} ] \geq 0$$

which can be efficiently solved as a semidefinite programming problem.

The total RIS control procedure may include one or more of the following steps:
Step 1: Setting maximum iteration number, selecting a feasible initial value for \hat{Θ} based on the constraints;
Step 2: Given \hat{Θ}, updating auxiliary variable β_{K}*=ψₖ by equation (F);
Step 3: Calculating ηₖ* by equation (K), and generating Λ and ψ accordingly;
Step 4: Calculating σₘ by solving problem (N);
Step 5: Updating \hat{Θ} by

$${\hat{Θ}}^{*} = \frac{Ψ}{Λ + diag ( \hat{σ} )} ;$$

Step 6: Repeating Step 2 until the value converges, or the iteration number reaches the predefined maximum value; and/or
Step 7: Outputting the maximum transmission rate and optimal RIS phase shift under given transmission power of network nodes 16.

In Co-HDRL, MBS 16a may include a meta controller 32 for sleep control, which is configured to decide the long-term on/off status of attached SBSs 16b. Then, each SBS 16b is considered as a sub-controller to adjust its short-term transmission power level. The sleep control is referred to high-level policy instructions for SBSs 16b, and the SBSs 16b can provide reward feedback to the meta controller 32 to evaluate the sleep control policies.

For the SBS sub-controller, define the state, action and reward by:
State: The state s_{sub} is defined by the total transmission demand level of attached WDs:

$${s}_{s u b} = \frac{{\sum }_{k ∈ {𝒦}_{b}} {W}_{b , k}}{{W}_{b}^{max}} \qquad ( O )$$

where W_{b,k} represents the transmission demand of WD k (i.e., buffer size), [symbol] represents the set of WDs that are associated with b^{th} SBS 16b. W_{b}^{max} is the max transmission demand of b^{th} SBS 16b, which is referred to as a constant value to normalize transmission demand in the current time slot. Assume, for example that the WD daily transmission demand follows specific patterns.
Action: The action a_{sub} consists of the transmission power P_{b};
Reward: The low-level reward of sub-controller is:

$${r}_{sub} = \{ \begin{matrix}\frac{{\sum }_{k ∈ {𝒦}_{b}} {D}_{b , k}}{{E}_{b}} - ϕ {n}_{b} , & active mode \\ 0 , & sleep mode\end{matrix} \qquad ( P )$$

where D_{b,k} is the throughput of WD k that belongs to network node 16 b. D_{b,k} depends on current the traffic demand level of WDs 22 and the channel capacity between network node 16 and WDs 22. This means that the network node 16 has to change the channel capacity level to adapt to dynamic WD 22 demands. n_{b} is a binary variable: n_{b}=1 means the SBS 16b is overloaded; otherwise n_{b}=0. Here, overloading indicates the transmission demand has exceeded the network node 16 channel capacity, and consequently attached WDs may experience a long queuing delay. Define ¢ as a penalty factor to avoid overloading and guarantee network performance.

For the MBS meta controller 32:
State: The state of MBS meta controller 32, includes the transmission demand level of all network nodes 16:

$${s}_{meta} = [ \frac{{\sum }_{k ∈ {𝒦}_{1}} {W}_{1 , k}}{{W}_{1}^{max}} , \frac{{\sum }_{k ∈ {𝒦}_{2}} {W}_{2 , k}}{{W}_{2}^{max}} , … , \frac{{\sum }_{k ∈ {𝒦}_{\vert ℬ \vert}} {W}_{\vert ℬ \vert , k}}{{W}_{\vert ℬ \vert}^{max}} ] \qquad ( Q )$$

where [symbol] is the set of all network nodes.
High-level Goals: Given the transmission demand level of all network nodes 16, the meta controller 32 can produce sleep control decisions for SBS 16b sub-controllers gₘₑₜₐ=[q₁, q₂, . . . , q_{b}, . . . , [symbol] ];
High-level reward: The meta controller 32 is responsible for the overall performance of all network nodes, and the high-level reward is given by the average EE of the whole cell:

$${r}_{meta} = \frac{{\sum }_{b ∈ ℬ} {\sum }_{k ∈ {𝒦}_{b}} {D}_{b , k}}{{\sum }_{b ∈ ℬ} {E}_{b}} - ϕ {\sum }_{b ∈ ℬ} {n}_{b} \qquad ( R )$$

Then, in Co-HDRL, the neural networks are trained by:

$$L ( w ) = E r ( {r}^{t} + γQ ( {s}^{t + 1} , arg {max}_{a} Q ( {s}^{t + 1} , a , w ) , {w}^{′} ) - Q ( {s}^{t} , {a}^{t} , w ) ) \qquad ( S )$$

where s^{t}, a^{t} and r^{t} are the state, action and reward at time slot t, respectively. w and w′ are the weight of main and target networks. γ is the discount factor. Q(s^{t}, a^{t}, w) is current Q-value that is predicted by the main network, and

$$Q ( {s}^{t + 1} , arg {max}_{a} Q ( {s}^{t + 1} , a , w ) , {w}^{′} )$$

is the target Q-value produced by target network. Decoupling the action selection and evaluation can provide a more accurate target for the main network training, which may further reduce the Q-value prediction error.

In Co-HDRL, first, the meta controller 32 selects a high-level goal gₘₑₜₐ, which indicates the sleep control decisions on sub-controllers. gₘₑₜₐ is temporarily fixed in the following several time slots, and sub-controllers select actions, receive rewards, and train their networks accordingly. The transmission power of sub-controllers is sent to the RIS control module for phase shift optimization. Based on the long-term performance of sub-controllers, the meta controller 32 receives an average reward rₘₑₜₐ from the wireless environment and moves to the next state sₘₑₜₐ. The new experience may be sent to the experience pool. Then the agent may sample a random mini-batch from the experience pool, and train the main network as equation(S). The target network may copy the main network weight after several training, which guarantees a stable target for the main network training.

For the meta controller 32, a cross-entropy enabled policy may be employed. More specifically, the cross-entropy may be used as a metric to evaluate the stationarity of sub-controllers' actions. Then the defined metric is used for high-level goal exploration.

Given a random variable x, and N^{X} is the total number of possible outcomes of x, then the entropy of x in set X is defined by:

$$I ( X ) = - {\sum }_{i = 1}^{{N}^{x}} pr ( {X}_{i} ) log ( {X}_{i} ) \qquad ( T )$$

where pr(xᵢ) is the probability of xᵢ in set X, and Σᵢ₌₁^{N}^{^{X}}pr(xᵢ)=1.

Then the Kullback-Leibler divergence is used to define the relative entropy from one distribution X to another distribution Y of variable x:

$${D}_{K L} ( X ‖ Y ) = {\sum }_{i = 1}^{{N}^{X}} p r ( {x}_{i} ) log \frac{pr ( {x}_{i} )}{{pr}^{′} ( {x}_{i} )} \qquad ( U )$$

where pr(xᵢ) is the probability of xᵢ in set Y.

Consider X as the set of action selection history of sub-controllers, and Y is the set of actions selected in the current time interval. Consequently, apply D_{KL}(X∥Y) to measure the stationarity of the low-level action selection policy. Moreover, rewrite equation (U) by:

$${D}_{K L} ( X ‖ Y ) = - I ( X ) - {\sum }_{i = 1}^{{N}^{X}} pr ( {x}_{i} ) log ( {pr}^{′} ( {x}_{i} ) ) \qquad ( V )$$

where I(X) is the entropy of the action selection distribution history, and Y is the action selection distribution in the current time interval. The history distribution X is generally more stable than current distribution Y. It means Σᵢ₌₁^{N}^{^{X}}pr(xᵢ)log(pr′(xᵢ)) item contributes more to the uncertainty, which is known as the cross-entropy. Consequently, the cross entropy is used to represent the stationarity of the sub-controllers.

Multiple sub-controllers may be employed and the cross-entropy of b^{th} sub-controller under high-level goal gₘₑₜₐ is:

$$I ( {X}_{b , t - 1} , {Y}_{b , t} \vert {g}_{meta} ) = - {\sum }_{i = 1}^{{A}_{{g}_{meta}}} p r ( {a}_{i} ) log ( p {r}^{′} ( {a}_{i} ) ) \qquad ( W )$$

where X_{b,t-1} is the accumulated action selection distribution of sub-controllers in former t−1 time slots under high-level goal gₘₑₜₐ, Y_{b,t} is the action selection distribution under gₘₑₜₐ in current time slot, and A_{g}_{ₘₑₜₐ} is the action set of sub-controllers under gₘₑₜₐ.

Finally, in the exploration phase, the meta controller 32 selects high-level goals by:

$$p r ( {g}_{meta} \vert {s}_{meta} ) = \frac{tanh ( {\sum }_{b ∈ {ℬ}_{- M}} I ( {X}_{b , t - 1} , {Y}_{b , t} \vert {g}_{meta} ) )}{{\sum }_{{g}_{m e ta ∈ 𝒢}} tanh ( {\sum }_{b ∈ {ℬ}_{- M}} I ( {X}_{b , t - 1} , {Y}_{b , t} \vert {g}_{meta} ) )} \qquad ( X )$$

where [symbol] indicates the set of controllers except the MBS meta controller 32. tan h indicates the Tanh function, which is applied to normalize all the cross-entropy values.

For low-level sub-controllers, a correlated equilibrium-based cooperation strategy may be employed. Correlated equilibrium is proposed as a multi-agent collaboration method, and cooperative action selections can bring higher stability than independent action selections. With correlated equilibrium, the SBS 16b sub-controllers choose actions by:

$${max}_{{a}_{s u b} ∈ {A}_{s u b}} {\sum }_{{\vec{a}}_{s u b} ∈ {A}_{s u b}} p r ( {\vec{a}}_{s u b} \vert {s}_{s u b} ) Q ( {s}_{sub} , {\vec{a}}_{sub} , w ) \qquad ( Y )$$

$$sub . to 0 \leq pr ( {\vec{a}}_{s u b} \vert {s}_{s u b} ) \leq 1$$

$${\sum }_{\vec{a} ∈ A} pr ( {\vec{a}}_{s u b} \vert {s}_{s u b} ) = 1$$

$${\sum }_{{a}_{- b} ∈ {A}_{- b}} pr ( {\vec{a}}_{s u b} \vert {s}_{s u b} ) ( Q ( {s}_{sub} , {\vec{a}}_{sub} , w ) - Q ( {s}_{sub} , {\vec{a}}_{- b} , {a}_{b} , w ) ) \geq 0$$

where pr(\vec{a}_{sub}|s_{sub}) is the probability of selecting action combination \vec{a}_{sub}=(a₁, a₂, . . . , [symbol] ) under state s_{sub}, \vec{a}_{-b} indicates the joint action of all sub-controllers except b^{th} sub-controller, and w is the main network weight, A_{-b} is the set of \vec{a}_{-b}.

Finally, note that the discount factor, network learning rate and training frequency are all tunable parameters in the proposed solution. The grid-search method may be applied by trying different parameter combinations and then select the best configurations.

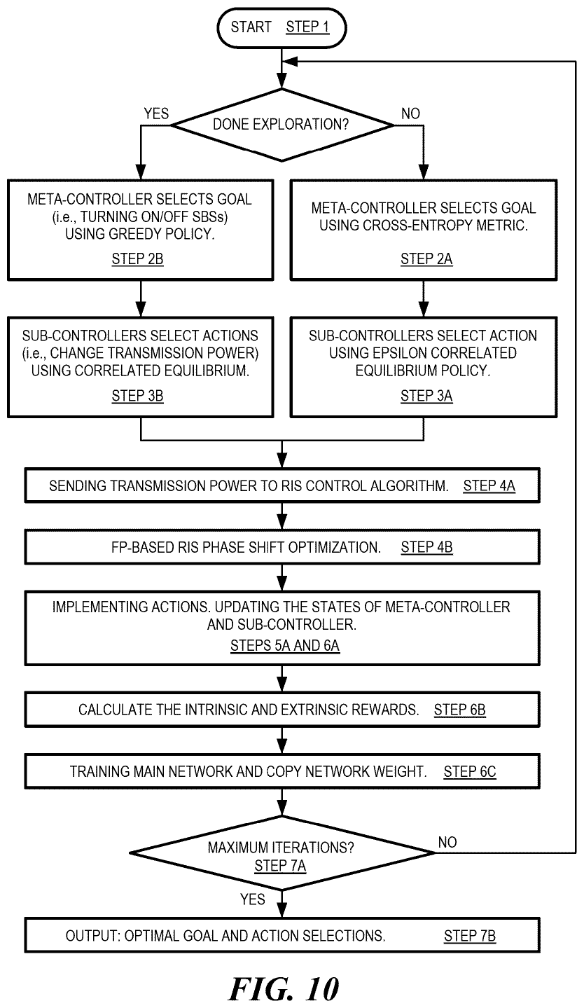

Some embodiments may include one or more of the following steps. Some of these steps and their relationships are shown in FIG. 10:
Step 1: Initializing the wireless network settings and Co-HDRL and FP algorithm parameters such as discount factor, maximum iteration numbers, training frequency, and so on.
Step 2: Meta-controller selects a long-term goal gₘₑₜₐ under current state sₘₑₜₐ using cross entropy metric (Step 2A) in exploration period, or greedy policy (Step 2B) in exploitation period.
Step 3: Sub-controllers select actions under the current state s_{sub} and gₘₑₜₐ using epsilon-correlated equilibrium policy (Step 3A) in the exploration period, or correlated equilibrium (Step 3B) in the exploitation period.
Step 4: The transmission power of network nodes 16 is sent to the RIS control algorithm (Step 4A) for phase shift optimization (Step 4B).
Step 5: Implementing the selected goals and actions (Step 5), including BS on/off decision, SBS 16b transmission power, and optimized RIS phase shift.
Step 6: Updating the system state (Step 6A) and calculating the rewards (Step 6B) of meta controller 32 and sub-controllers, respectively. Training the main network of controllers, and copying the network weight (Step 6C) from main network to target networks.
Step 7: If the algorithm reaches the maximum iteration numbers (Step 7A), then output the optimal goal and action sequences (Step 7B). If not, start again from Step 2.

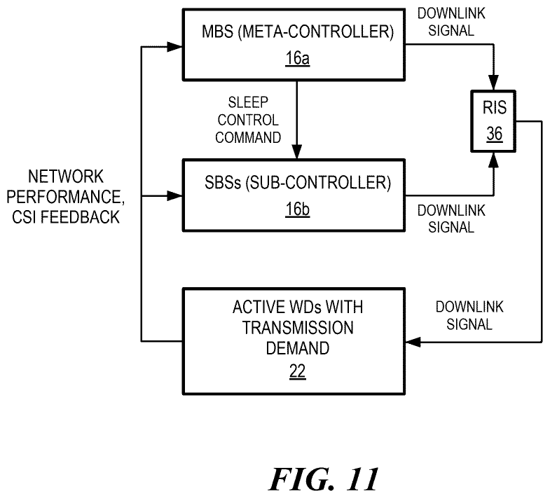

An example of an access network 12 that includes an MBS 16a, SBSs 16b and WDs 22 is shown in FIG. 11.

Some examples may include one or more of the following:
Example A1. A network node configured to communicate with a plurality of small base stations, SBSs, the network node configured to, and/or comprising a radio interface and/or comprising processing circuitry configured to:
jointly determine sleep control, transmission power control and reconfigurable intelligent surface, RIS, control for the plurality of SBSs based at least in part on a fractional programming, FP, algorithm, the FP algorithm configured to maximize a data rate for a plurality of
Example A2. The network node of Example A1, wherein jointly determining the sleep control, transmission power control and RIS control includes determining an optimal phase shift of an RIS based at least in part on maximizing a signal to interference plus noise ratio, SINR.
Example A3. The network node of any of Examples A1 and A2, wherein the network node, processing circuitry and/or radio interface are further configured to configure at least one of an SBS and an RIS based at least in part on the jointly determined controls.
Example A4. The network node of any of Examples A1-A3, wherein jointly determining the controls includes machine learning based at least in part on a measure of performance.
Example A5. The network node of Example A4, wherein the performance measure includes an average energy efficiency of the plurality of SBSs.
Example B1. A method implemented in a network node configured to communicate with a plurality of small base stations, the method comprising.
jointly determining sleep control, transmission power control and reconfigurable intelligent surface, RIS, control for the plurality of SBSs based at least in part on a fractional programming, FP, algorithm, the FP algorithm configured to maximize a data rate for a plurality of WDs.
Example B2. The method of Example B1, wherein jointly determining the sleep control, transmission power control and RIS control includes determining an optimal phase shift of an RIS based at least in part on maximizing a signal to interference plus noise ratio, SINR.
Example B3. The method of any of Examples B1 and B2, further comprising configuring at least one of an SBS and an RIS based at least in part on the jointly determined controls.
Example B4. The method of any of Examples B1-B3, wherein jointly determining the controls includes machine learning based at least in part on a measure of performance.
Example B5. The method of Example B4, wherein the performance measure includes an average energy efficiency of the plurality of SBSs.
Example C1. A network node configured to communicate with a master base stations, MBSs, the network node configured to, and/or comprising a radio interface and/or processing circuitry configured to:
choose an action based at least in part on a correlated equilibrium algorithm configured to maximize a function of a conditional probability of a set of actions for a given state of transmission demand by a plurality of wireless devices, WDs.
Example C2. The network node of Example C1, wherein choosing an action is based at least in part on a first reward, the first reward being based at least in part on a throughput for each WD.
Example C3. The network node of any of Examples C1 and C2, wherein the first reward is based at least in part on a penalty factor to avoid overload.
Example C4. The network node of any of Examples C1-C3, wherein choosing an action includes choosing a transmission power based at least in part on the transmission demand.
Example D1. A method implemented in a network node configured to communication with a master base station, MBS, the method comprising:
choose an action based at least in part on a correlated equilibrium algorithm configured to maximize a function of a conditional probability of a set of actions for a given state of transmission demand by a plurality of wireless devices, WDs.
Example D2. The method of Example D1, wherein choosing an action is based at least in part on a first reward, the first reward being based at least in part on a throughput for each WD.
Example D3. The method of any of Examples D1 and D2, wherein the first reward is based at least in part on a penalty factor to avoid overload.
Example D4. The method of any of Examples D1-D3, wherein choosing an action includes choosing a transmission power based at least in part on the transmission demand.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
BS Base stations
CSI Channel state information
Co-HDRL Cooperative hierarchical deep reinforcement learning
EE Energy efficiency
FP Fractional Programming
HetNets Heterogeneous networks
LOS Line-of-sight
MBS Main base stations
MDP Markov decision process
NLOS non-line-of-sight
RAN Radio access network
RIS Reconfigurable intelligent surfaces
RL Reinforcement learning
SBS Small base stations
SINR Signal-to-interference-plus-noise ratio
UE User equipment
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a plurality of small base stations, SBSs, the network node comprising processing circuitry configured to:
jointly determine sleep control, transmission power control and reconfigurable intelligent surface, RIS, control for the plurality of SBSs based at least in part on a fractional programming, FP, algorithm, the FP algorithm configured to maximize a data rate for a plurality of wireless devices, WDs.

2-8. (canceled)

9. A method in a network node configured to communicate with a plurality of small base stations, SBSs, the method comprising:
jointly determining sleep control, transmission power control and reconfigurable intelligent surface, RIS, control for the plurality of SBSs based at least in part on a fractional programming, FP, algorithm, the FP algorithm configured to maximize a data rate for a plurality of wireless devices, WDs.

10. The method of claim 9, further comprising determining a long-term on/off status of an SBS of the plurality of SBSs and to provide a policy instruction to the SBS.

11. The method of claim 10, wherein the policy instruction is based at least in part on reward feedback from the SBS.

12. The method of claim 10, further comprising determining a sleep control decision for the SBS based at least in part on a transmission demand level of the plurality of SBSs.

13. The method of claim 9, wherein jointly determining the sleep control, transmission power control and RIS control includes determining an optimal phase shift of an RIS based at least in part on maximizing a signal to interference plus noise ratio, SINR.

14. The method of claim 9, further comprising configuring at least one of an SBS and an RIS based at least in part on the jointly determined controls.

15. The method of claim 9, wherein jointly determining the jointly determined controls includes performing machine learning based at least in part on a measure of performance.

16. The method of claim 15, wherein the performance measure includes an average energy efficiency of the plurality of SBSs.

17-23. (canceled)

24. A method in a network node configured as a small base station, SBS, to communicate with a master base station, MBS, the method comprising:
selecting an action based at least in part on a correlated equilibrium algorithm configured to maximize a function of a conditional probability of a set of actions for a given state of transmission demand by a plurality of wireless devices, WDs.

25. The method of claim 24, wherein selecting the action is based at least in part on a policy instruction from the MBS.

26. The method of claim 24, further comprising transmitting an indication of the selected action to the MBS.

27. The method of claim 26, further comprising transmitting an indication of average efficiency to the MBS.

28. The method of claim 24, wherein
selecting an action is based at least in part on a first reward, the first reward being based at least in part on a throughput for each WD.

29. The method of claim 28, wherein the first reward is based at least in part on a penalty factor to avoid overload.

30. The method of claim 24, wherein selecting an action is based at least in part on one of a correlated equilibrium policy in an exploration period and a correlated equilibrium in an exploitation period.
